(19) United States
(12) Patent Application Publication
(10) Pub. No.: US 2026/0340972 A1
(43) Pub. Date: Oct. 29, 2026

(54) VIDEO PROCESSING SYSTEM, VIDEO PROCESSING METHOD, AND VIDEO PROCESSING APPARATUS

(71) Applicant: NEC CORPORATION, Minato-ku, Tokyo (JP)

(72) Inventors: Yasunori BABAZAKI, Tokyo (JP); Katsuhiko TAKAHASHI, Tokyo (JP); Ryuhei ANDO, Tokyo (JP); Koichi NIHEI, Tokyo (JP); Florian BEYE, Tokyo (JP); Takanori IWAI, Tokyo (JP); Hayato ITSUMI, Tokyo (JP)

(73) Assignee: NEC CORPORATION, Minato-ku, Tokyo (JP)

(21) Appl. No.: 19/103,851

(22) PCT Filed: Aug. 30, 2022
(86) PCT No.: PCT/JP2022/032586

§ 371 Date: Feb. 14, 2025

(51) Int. Cl. G06V 10/25; G06V 10/82; G06V 10/98; G06V 20/52; G06V 40/20

(52) U.S. Cl. CPC G06V 10/25; G06V 10/82; G06V 10/98; G06V 20/52; G06V 40/20

(57) ABSTRACT

A video processing system (10) includes an image quality control unit (11) that controls image quality of a gaze region including a gaze target in a video input to a video processing system (10), a recognition unit (12) that performs recognition processing regarding an object included in the video in which the image quality of the gaze region is controlled by the image quality control unit (11), and an extraction unit (13) that extracts the gaze target included in the gaze region controlled by the image quality control unit (11) based on uncertainty of a recognition result of the recognition processing performed by the recognition unit (12).

### TECHNICAL FIELD

The present disclosure relates to a video processing system, a video processing method, and a video processing apparatus.

### BACKGROUND ART

A system that performs monitoring and the like by applying a detection technique and a recognition technique using machine learning to a video captured by a camera is being developed.

Patent Literature 1 is known as a related technique. Patent Literature 1 discloses that in a remote monitoring system that transmits a video captured by a camera mounted on a vehicle via a network and analyzes the video at a remote monitoring center, image quality of a region including a target object detected from the video is improved, image quality of other regions is reduced, and the video is transmitted.

### CITATION LIST

### Patent Literature

Patent Literature 1: International Patent Publication No. WO2022/074700

### SUMMARY OF INVENTION

### Technical Problem

In a related technique such as Patent Literature 1, a region including a detected target object is controlled so as to always have high image quality. For this reason, in the related technique, it may be difficult to appropriately suppress the data amount of the video.

In view of such a problem, an object of the present disclosure is to provide a video processing system, a video processing method, and a video processing apparatus capable of appropriately controlling a data amount of a video.

### Solution to Problem

A video processing system according to the present disclosure includes: an image quality control means for controlling image quality of a gaze region including a gaze target in an input video; a recognition means for performing recognition processing regarding an object included in the video in which the image quality of the gaze region is controlled; and an extraction means for extracting the gaze target based on uncertainty of a recognition result of the recognition processing.

A video processing method according to the present disclosure includes: controlling image quality of a gaze region including a gaze target in an input video; performing recognition processing regarding an object included in the video in which the image quality of the gaze region is controlled; and extracting the gaze target based on uncertainty of a recognition result of the recognition processing.

A video processing apparatus according to the present disclosure includes: an image quality control means for controlling image quality of a gaze region including a gaze target in an input video; a recognition means for performing recognition processing regarding an object included in the video in which the image quality of the gaze region is controlled; and an extraction means for extracting the gaze target based on uncertainty of a recognition result of the recognition processing.

### Advantageous Effects of Invention

According to the present disclosure, it is possible to provide a video processing system, a video processing method, and a video processing apparatus capable of appropriately controlling a data amount of a video.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to the example embodiment.

FIG. 3 is a flowchart illustrating an outline of a video processing method according to the example embodiment.

FIG. 4 is a configuration diagram illustrating a basic configuration of a remote monitoring system.

FIG. 5 is a configuration diagram illustrating a configuration example of a terminal according to a first example embodiment.

FIG. 6 is a configuration diagram illustrating a configuration example of a center server according to the first example embodiment.

FIG. 7 is a configuration diagram illustrating a configuration example of an action recognition unit according to the first example embodiment.

FIG. 8 is a configuration diagram illustrating a configuration example of a predictor according to the first example embodiment.

FIG. 9 is a flowchart illustrating an operation example of the remote monitoring system according to the first example embodiment.

FIG. 10 is a diagram for describing video acquisition processing according to the first example embodiment.

FIG. 11 is a diagram for describing object detection processing according to the first example embodiment.

FIG. 12 is a flowchart illustrating an operation example of action recognition processing according to the first example embodiment.

FIG. 13 is a diagram for describing the action recognition processing according to the first example embodiment.

FIG. 14 is a flowchart illustrating an operation example of gaze target extraction processing according to the first example embodiment.

FIG. 15 is a diagram for describing an example in which there is variation in recognition results in the gaze target extraction processing according to the first example embodiment.

FIG. 16 is a diagram for describing another example in which there is variation in the recognition results in the gaze target extraction processing according to the first example embodiment.

FIG. 17 is a diagram for describing an example in which there is no variation in the recognition results in the gaze target extraction processing according to the first example embodiment.

FIG. 18 is a diagram for describing another example in which there is no variation in the recognition results in the gaze target extraction processing according to the first example embodiment.

FIG. 19 is a diagram for describing gaze region determination processing according to the first example embodiment.

FIG. 20 is a configuration diagram illustrating a configuration example of an action recognition unit according to a second example embodiment.

FIG. 21 is a flowchart illustrating an operation example of action recognition processing according to the second example embodiment.

FIG. 22 is a diagram for describing dropout processing according to the second example embodiment.

FIG. 23 is a diagram for describing dropout processing according to the second example embodiment.

FIG. 24 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

In a system that collects a video via a network and recognizes an object, an action, or the like in the video, it is preferable to suppress the data amount of the video to be transmitted as much as possible because the band of the network that transmits the video is limited. For example, the data amount of the video can be suppressed by increasing the compression rate of the video. However, in a case where the video compression rate is high or in a case where the data loss rate is high, erroneous recognition increases, and thus the recognition accuracy decreases. Therefore, in the example embodiments, it is possible to prevent the erroneous recognition while suppressing the data amount of a video to be transmitted as much as possible. For example, erroneous recognition of important events, such as unsafe or dangerous actions is prevented.

### Outline of Example Embodiment

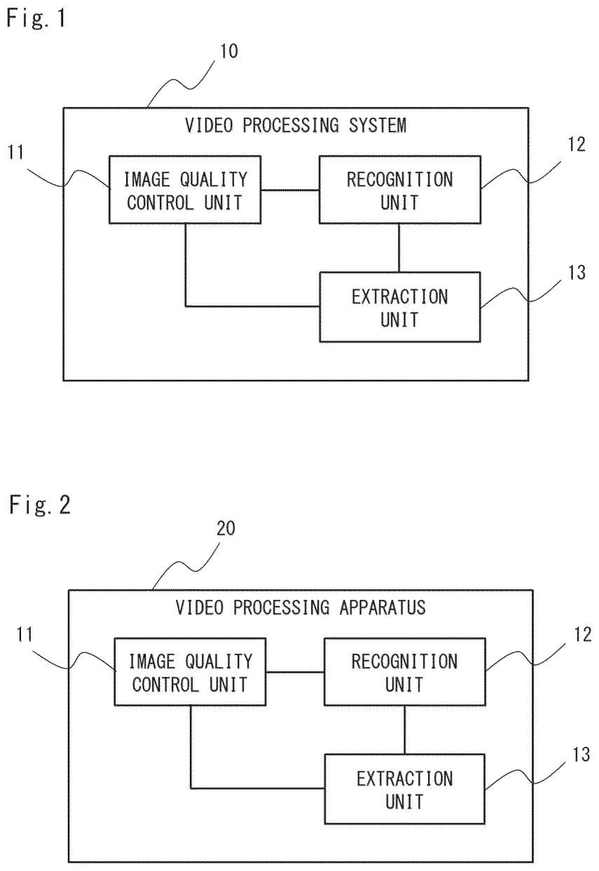

First, an outline of an example embodiment will be described. FIG. 1 illustrates a configuration outline of a video processing system 10 according to the example embodiment. The video processing system 10 can be applied to, for example, a remote monitoring system that collects videos via a network and monitors the videos.

As illustrated in FIG. 1, the video processing system 10 includes an image quality control unit 11, a recognition unit 12, and an extraction unit 13.

The image quality control unit 11 controls the image quality of a gaze region including a gaze target in the input video. For example, the image quality control unit 11 may make the image quality of the gaze region higher, that is, sharper than other regions. The recognition unit 12 performs recognition processing regarding an object included in the video in which the image quality of the gaze region is controlled. For example, the recognition processing regarding an object is action recognition processing of recognizing an action of an object, but may be processing of recognizing information, features, and the like regarding other objects.

The extraction unit 13 extracts a gaze target based on the uncertainty of the recognition result of the recognition processing by the recognition unit 12. The uncertainty of the recognition results is variation in the recognition results. For example, the recognition unit 12 may include a plurality of action predictors that have learned different learning data, and the extraction unit 13 may extract the gaze target based on the variation in a plurality of action recognition results output from the plurality of action predictors. In this case, the gaze target may be extracted based on variation in action labels included in the action recognition results or in scores of the action labels. In addition, the recognition unit 12 may include one action predictor, and the extraction unit 13 may extract the gaze target based on variation in a plurality of action recognition results output by one action predictor performing action recognition a plurality of times. The extraction of a gaze target means selecting a gaze target from among candidates included in the recognition result.

Note that the video processing system 10 may include one apparatus or a plurality of apparatuses. FIG. 2 illustrates a configuration of a video processing apparatus 20 according to the example embodiment. As illustrated in FIG. 2, the video processing apparatus 20 may include the image quality control unit 11, the recognition unit 12, and the extraction unit 13 illustrated in FIG. 1. In addition, a part or all of the video processing system 10 may be disposed on an edge or a cloud. For example, in a system that monitors a video captured in a site via a network, an edge is an apparatus disposed at the site or near the site, and is an apparatus close to a terminal in a hierarchy of the network. For example, the image quality control unit 11 may be disposed in an edge terminal, and the recognition unit 12 and the extraction unit 13 may be disposed in a cloud server. Further, functions may be distributed and disposed in the cloud.

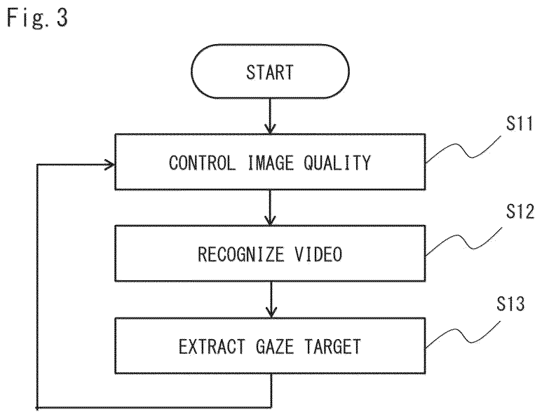

FIG. 3 illustrates a video processing method according to the example embodiment. For example, the video processing method according to the example embodiment is performed by the video processing system 10 in FIG. 1 or the video processing apparatus 20 in FIG. 2. As illustrated in FIG. 3, first, the image quality of a gaze region including a gaze target in the input video is controlled (S11). Next, recognition processing is performed regarding an object included in the video in which the image quality of the gaze region is controlled (S12). Next, a gaze target is extracted based on the uncertainty of the recognition result of the recognition processing (S13). Further, the processing returns to S11, and the image quality of the gaze region including the extracted gaze target is controlled on the input video.

As described above, the video processing system according to the example embodiment recognizes an action or the like of an object from a video having controlled image quality, and extracts a gaze target based on uncertainty of a recognition result. For example, in a case where the recognition results vary, there is a possibility that the action or the like cannot be correctly recognized, and the reliability of the recognition result is low. Therefore, the target object corresponding to the recognition result is improved in image quality as the gaze target, so that the action or the like can be correctly recognized. In addition, since a region other than a target to be gazed at can be compressed, the data amount of a video to be transmitted can be suppressed.

### Basic Configuration of Remote Monitoring System

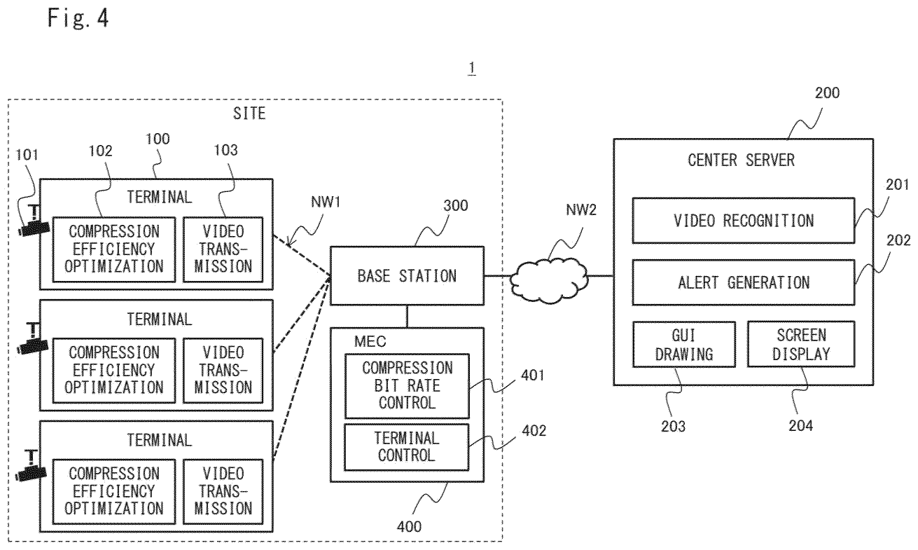

Next, the remote monitoring system that is an example of a system to which the example embodiment is applied will be described. FIG. 4 illustrates a basic configuration of a remote monitoring system 1. The remote monitoring system 1 is a system that monitors a captured area by a video captured by a camera. Hereinafter, the present example embodiment will be described as a system that remotely monitors work of a worker at a site. For example, the site may be an area where people and machines operate, such as a work site such as a construction site, a square where people gather, or a school. In the present example embodiment, hereinafter, the work will be described as construction work, civil engineering work, or the like, but the work is not limited thereto.

Note that, since the video includes a plurality of time-series images (also referred to as frames), the video and the image can be paraphrased with each other. That is, the remote monitoring system can be said to be a video processing system that processes a video or an image processing system that processes an image.

As illustrated in FIG. 4, the remote monitoring system 1 includes a plurality of terminals 100, a center server 200, a base station 300, and a MEC 400. The terminal 100, the base station 300, and the MEC 400 are disposed on the site side, and the center server 200 is disposed on the center side. For example, the center server 200 is disposed in a data center, a monitoring center, or the like disposed at a position away from the site. The site side is an edge side of the system, and the center side is also a cloud side. Note that the center server 200 may be configured by one apparatus or a plurality of apparatuses. In addition, a part or all of the center server 200 may be disposed in a cloud. For example, a video recognition function 201 and an alert generation function 202 may be disposed in the cloud, and a GUI drawing function 203 and a screen display function 204 may be disposed in a monitoring center or the like.

The terminal 100 and the base station 300 are communicatively connected by a network NW1. The network NW1 is, for example, a wireless network such as a 4G, local 5G/5G, long term evolution (LTE), or a wireless LAN network.

The base station 300 and the center server 200 are communicatively connected by a network NW2. The network NW2 includes, for example, a core network such as a 5th generation core network (5GC) or an evolved packet core (EPC), the Internet, or the like. It can also be said that the terminal 100 and the center server 200 are communicatively connected via the base station 300. The base station 300 and the MEC 400 are communicatively connected by any communication method, and the base station 300 and the MEC 400 may be one apparatus.

The terminal 100 is a terminal apparatus connected to the network NW1, and is also a video generation apparatus that generates a video of the site. The terminal 100 acquires a video captured by the camera 101 installed at the site, and transmits the acquired video to the center server 200 via the base station 300.

Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency and a video transmission function 103. The compression efficiency optimization function 102 performs ROI (region of interest; also referred to as a gaze region) control for controlling the image quality of an ROI. The compression efficiency optimization function 102 reduces the bit rate by reducing the image quality of a region around the ROI including a person or an object, while maintaining the image quality of the ROI. The video transmission function 103 transmits a video having the controlled image quality to the center server 200.

The base station 300 is a base station apparatus for the network NW1, and is also a relay apparatus that relays communication between the terminal 100 and the center server 200. For example, the base station 300 is a local 5G base station, a 5G next generation node B (gNB), an LTE evolved node B (eNB), an access point of a radio LAN, or the like, but may be another relay apparatus.

The multi-access edge computing (MEC) 400 is an edge processing apparatus disposed on the edge side of the system. The MEC 400 is an edge server that controls the terminal 100, and has a compression bit rate control function 401 that controls a bit rate of the terminal and a terminal control function 402. The compression bit rate control function 401 controls a bit rate of the terminal 100 by adaptive video distribution control or quality of experience (QoE) control. For example, the compression bit rate control function 401 predicts the recognition accuracy to be obtained while suppressing the bit rate in accordance with the communication environment of the networks NW1 and NW2, and assigns the bit rate to the camera 101 of each terminal 100 to improve the recognition accuracy. The terminal control function 402 controls the terminal 100 to transmit the video having the assigned bit rate. The terminal 100 encodes the video to have the assigned bit rate, and transmits the encoded video.

The center server 200 is a server installed on the center side of the system. The center server 200 may be one or a plurality of physical servers, a cloud server constructed on a cloud, or another virtualization server. The center server 200 is a monitoring apparatus that monitors work in a site by recognizing the work of a person from a camera video of the site. The center server 200 is also a recognition apparatus that recognizes an action or the like of a person in the video transmitted from the terminal 100.

The center server 200 has the video recognition function 201, the alert generation function 202, the GUI drawing function 203, and the screen display function 204. The video recognition function 201 inputs the video transmitted from the terminal 100 to a video recognition artificial intelligence (AI) engine, thereby recognizing the work performed by a worker, that is, the type of action of the person. The alert generation function 202 generates an alert in accordance with the recognized work. The GUI drawing function 203 displays a graphical user interface (GUI) on a screen of a display device. The screen display function 204 displays a video, a recognition result, an alert, and the like of the terminal 100 on the GUI.

### First Example Embodiment

Next, a first example embodiment will be described. In the present example embodiment, an example will be described in which a gaze target is extracted based on variation in action recognition results by a plurality of predictors.

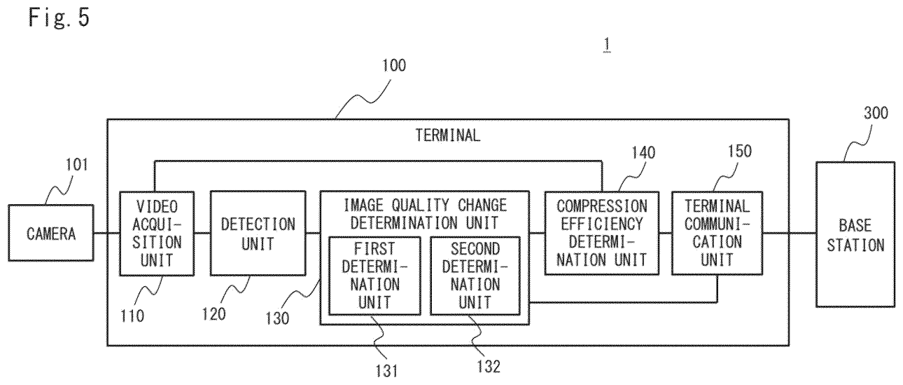

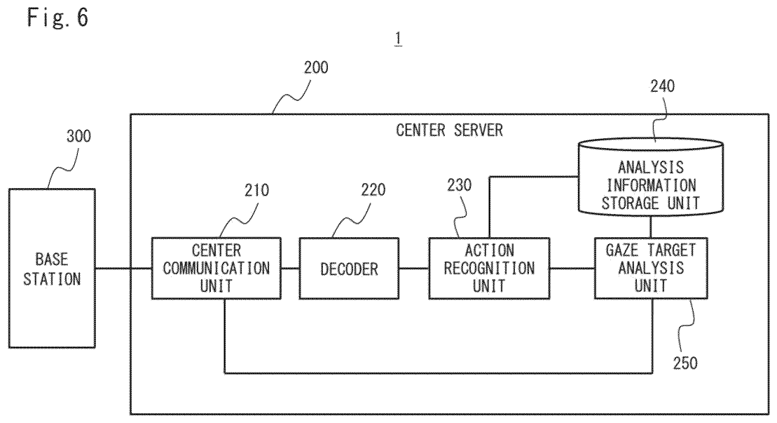

First, a configuration of a remote monitoring system according to the present example embodiment will be described. A basic configuration of the remote monitoring system 1 according to the present example embodiment is as illustrated in FIG. 4. Here, a configuration example of the terminal 100 and the center server 200 will be described. FIG. 5 illustrates a configuration example of the terminal 100 according to the present example embodiment, and FIG. 6 illustrates a configuration example of the center server 200 according to the present example embodiment. Note that the configuration of each apparatus is an example, and another configuration may be used as long as the operation to be described layer according to the present example embodiment can be performed. For example, some functions of the terminal 100 may be disposed in the center server 200 or another apparatus, or some functions of the center server 200 may be disposed in the terminal 100 or another apparatus.

As illustrated in FIG. 5, the terminal 100 includes a video acquisition unit 110, a detection unit 120, an image quality change determination unit 130, a compression efficiency determination unit 140, and a terminal communication unit 150.

The video acquisition unit 110 acquires a video (also referred to as an input video) captured by the camera 101. For example, the input video includes a person who is a worker who performs work on site, a work object used by the person, and the like. The video acquisition unit 110 is also an image acquisition unit that acquires a plurality of time-series images.

The detection unit 120 is an object detection unit that detects an object in the acquired input video. The detection unit 120 detects an object in each image included in the input video, and gives a label of the detected object, that is, an object label. The object label is a class of an object and indicates a type of the object. For example, the object label includes a person, a car, a robot, a hammer, and the like. The detection unit 120 extracts a rectangular region including an object from each image included in the input video, recognizes the object in the extracted rectangular region, and gives a label of the recognized object. The rectangular region is a bounding box or an object region. Note that the object region including the object is not limited to the rectangular region, and may be a region having a circular or amorphous silhouette, or the like. The detection unit 120 calculates a feature amount of an image of the object included in the rectangular region, and recognizes the object based on the calculated feature amount. For example, the detection unit 120 recognizes the object in the image by an object recognition engine using machine learning such as deep learning. The object can be recognized by performing machine learning on the feature of the image of the object and the object label. The detection result of the object includes the object label, position information of the rectangular region including the object, and the like. The position information of the object is, for example, coordinates of each vertex of the rectangular region, and may be a position of the center of the rectangular region or a position of a certain point of the object. The detection unit 120 transmits the detection result of the object to the image quality change determination unit 130.

The image quality change determination unit 130 determines a gaze region (ROI) that is an image quality change region for changing the image quality of the acquired input video. The image quality change determination unit 130 is a determination unit that determines the gaze region. The gaze region is a region including a gaze target, and is a region for improving image quality, that is, improving sharpness. In addition, it can be said that the gaze region is a region that secures the image quality for action recognition.

For example, the image quality change determination unit 130 includes a first determination unit 131 and a second determination unit 132. For example, first, the first determination unit 131 determines a gaze region, and after the center server 200 recognizes an action, the second determination unit 132 determines the gaze region. Note that determination of the gaze region by the first determination unit 131 may be omitted, and only determination of the gaze region by the second determination unit 132 may be performed. The first determination unit 131 determines the gaze region of the input video based on the detection result of the object detected in the input video. The first determination unit 131 determines the gaze region based on the position information of the object having the label, which is a gaze target among detection objects detected in the input video by the detection unit 120. The gaze target may be a person who is a target of action recognition, and may include a work object that may be used by the person in work. For example, the label of the work object is set in advance as a label of an object related to a person. Note that the target of the action recognition is not limited to a person, and may be an object such as heavy machine or a robot. That is, an action including work performed by heavy machine or a robot may be recognized.

In a case where information is fed back from the center server 200 that has recognized the action, the second determination unit 132 determines the gaze region of the input video based on the fed-back information. In this example, extraction gaze target information, which is information of a gaze target extracted by the center server 200, is fed back. The extraction gaze target information is information regarding the gaze target, and is information indicating a gaze target extracted by the center server 200 performing action recognition. The extraction gaze target information is position information of the gaze target and includes position information of a rectangular region of the gaze target. For example, the second determination unit 132 determines the rectangular region indicated by the acquired extraction gaze target information as the gaze region. That is, the region that secures the image quality of the input video is determined based on the extracted position of the gaze target.

The compression efficiency determination unit 140 determines the compression rate of the gaze region or a region other than the gaze region, and compresses the video. The compression efficiency determination unit 140 is an encoder that encodes the input video in accordance with the determined compression rate. The compression efficiency determination unit 140 performs encoding by a moving image encoding method such as H.264 or H.265, for example. In addition, the compression efficiency determination unit 140 encodes the input video to obtain the bit rate assigned from the compression bit rate control function 401 of the MEC 400.

The compression efficiency determination unit 140 is an image quality control unit that controls the image quality of the gaze region determined by the image quality change determination unit 130, and corresponds to the image quality control unit 11 in FIG. 1. In addition, the compression efficiency determination unit 140 can also be said to be an image quality improving unit that improves the image quality of the gaze region. The gaze region is a region determined by either the first determination unit 131 or the second determination unit 132. The compression efficiency determination unit 140 compresses each of the gaze region and the other region at a predetermined compression rate, thereby performing encoding such that the image quality of the gaze region has a predetermined quality. That is, by changing the compression rates of the gaze region and the other region, the gaze region is made higher in image quality than the other region. It can also be said that the image quality of other regions is made lower than the gaze region. For example, the image qualities of the gaze region and the other regions are controlled within a range of the bit rate assigned from the compression bit rate control function 401 of the MEC 400. Note that the image quality of the gaze region may be controlled by changing not only the compression rate but also a resolution, a frame rate, and the like of the image.

Furthermore, the image quality of the gaze region may be controlled by changing an information amount of the color of the image, for example, the color, the grayscale, black and white, or the like.

The terminal communication unit 150 transmits the encoded data encoded by the compression efficiency determination unit 140 to the center server 200 via the base station 300. The terminal communication unit 150 is a transmission unit that transmits a video in which the image quality of the gaze region is controlled. In addition, the terminal communication unit 150 receives the extraction gaze target information transmitted from the center server 200 via the base station 300. The terminal communication unit 150 is an acquisition unit that acquires extraction gaze target information. The terminal communication unit 150 is an interface capable of communicating with the base station 300, and is, for example, a radio interface of 4G, local 5G/5G, LTE, a radio LAN, or the like, and may be a radio or wired interface of any other communication scheme. The terminal communication unit 150 may include a first terminal communication unit that transmits encoded data and a second terminal communication unit that receives extraction gaze target information. The first terminal communication unit and the second terminal communication unit may be communication units of the same communication scheme, or may be communication units of different communication schemes.

As illustrated in FIG. 6, the center server 200 includes a center communication unit 210, a decoder 220, an action recognition unit 230, an analysis information storage unit 240, and a gaze target analysis unit 250.

The center communication unit 210 receives encoded data transmitted from the terminal 100 via the base station 300. The center communication unit 210 is a reception unit that receives a video in which the image quality of the gaze region is controlled. In addition, the center communication unit 210 transmits the extraction gaze target information extracted by the gaze target analysis unit 250 to the terminal 100 via the base station 300. The center communication unit 210 is a notification unit that provides notification of extraction gaze target information. The center communication unit 210 is an interface capable of communicating with the Internet or a core network, and is, for example, a wired interface for IP communication, but may be a wired or radio interface of any other communication scheme. The center communication unit 210 may include a first center communication unit that receives encoded data and a second center communication unit that transmits the extraction gaze target information. The first center communication unit and the second center communication unit may be communication units of the same communication scheme, or may be communication units of different communication schemes.

The decoder 220 decodes the encoded data received from the terminal 100. The decoder 220 supports the encoding method of the terminal 100, and performs decoding by a moving image encoding method such as H.264 or H.265, for example. The decoder 220 performs decoding in accordance with the compression rate of each region to generate a decoded video (also referred to as a reception video).

The action recognition unit 230 is a recognition unit that recognizes an action of an object in the decoded reception video, and corresponds to the recognition unit 12 in FIG. 1. The action recognition unit 230 performs action recognition processing of recognizing an action of the gaze target on the video in which the image quality of the gaze region is controlled. The action recognition unit 230 detects an object from the reception video, and recognizes an action of the detected object. The action recognition unit 230 recognizes an action of a person who is a target of action recognition, and gives a label of the recognized action, that is, an action label. The action label is a class of action and indicates a type of action.

For example, the action recognition unit 230 recognizes the action of a person based on the person and a work object detected from the reception video. The action recognition unit 230 may recognize the action of the person by specifying the relevance between the person and the work object. The relevance between the person and the work object includes which object the person is using or whether the person is not using the object. For example, a work object may be specified for each person from a distance between the person and the work object, and an action may be recognized from the specified work object. For example, the action recognition unit 230 performs machine learning on a work object and a work related to a person, and recognizes an action of the person on a machine learning basis. Note that the present invention is not limited to the machine learning basis, the work object and the work related to a person may be associated with each other, and the action of the person may be recognized on the basis of a rule. For example, the work object and work content may be associated in advance, and the action of the person may be recognized based on the detected work object. In addition, in a case where the work object is not detected, the action may be recognized only from the person. For example, the posture or shape of the person and the work content may be associated in advance, and the action of the person may be recognized based on the detected posture or shape of the person. In the present example embodiment, the action recognition unit 230 includes a plurality of predictors that each predict an action from the reception video, and outputs action recognition results predicted by the plurality of predictors.

The analysis information storage unit 240 stores the analysis information analyzed by the action recognition unit 230. The analysis information includes an action recognition result, detection information of a person, detection information of a work object related to an action, and the like. Note that the action recognition result may include the detection information of a person and the detection information of a work object related to an action. The action recognition result includes a label of the recognized action, a score of the action label, identification information of a person who performs the recognized action, identification information of a work object used in the recognized action, and the like. The score of the action label indicates a certainty factor that is the certainty (probability) of the action label. The higher the score, the higher the possibility that the predicted action of the action label is correct. The detection information of the person includes position information of a rectangular region of the person, tracking information, and the like. The tracking information is trajectory information indicating a tracking result of an object. The detection information of the work object includes an object label, a score of the object label, position information of a rectangular region of the object, tracking information, and the like. For example, an action predictor (action recognition engine) of the action recognition unit 230 performs learning such that an object involved in an action is weighted, thereby extracting candidates for a work object, which may be related, for each image, and outputting information of the extracted candidates for the work object. For example, in a case where piling work is recognized, information of a hammer which is an object related to the action is output.

The gaze target analysis unit 250 is an extraction unit that extracts a gaze target based on the analysis information analyzed by the action recognition unit 230, and corresponds to the extraction unit 13 in FIG. 1. The analysis information may be acquired from the action recognition unit 230 or may be acquired from the analysis information storage unit 240. The gaze target analysis unit 250 determines a gaze target for securing image quality in order to prevent an action recognition error, based on the analyzed information. For example, the gaze target analysis unit 250 determines a gaze target based on an action recognition result. The gaze target analysis unit 250 sets, as the gaze target, a person having an action that is recognized by the action recognition unit 230, that is, a person having an action that is included in the action recognition result. In a case where an action is recognized from a person and a related work object, the person and the work object may be set as gaze targets. There may be a plurality of work objects related to a person, and the person and the plurality of work objects may be set as gaze targets. For example, in a case where the piling work is recognized, an object related to the work may be set as “pile” and “hammer”, and a person, “pile”, and “hammer” may be set as gaze targets.

In the present example embodiment, the gaze target analysis unit 250 extracts a gaze target based on the uncertainty of the action recognition result.

For example, the gaze target is determined based on variation in a plurality of action recognition results output from the plurality of predictors of the action recognition unit 230. The gaze target is determined based on variation in action labels included in the plurality of action recognition results or variation in scores of the action labels. For example, in a case where the variation in the action recognition results is larger than a predetermined range, a person and an object including a work object that has performed the action of the action label may be determined as the gaze targets.

The gaze target analysis unit 250 outputs the position information of the rectangular region of the extracted gaze target as the extraction gaze target information. The position information is, for example, coordinates of each vertex of the rectangular region, and may be a position of the center of the rectangular region or a position of a certain point of the gaze target. The extraction gaze target information is not limited to the position information as the information regarding the extracted gaze target, and may include information analyzed by the action recognition unit 230, such as a feature of an object label or an image of the gaze target, an action label, and a score of the action label.

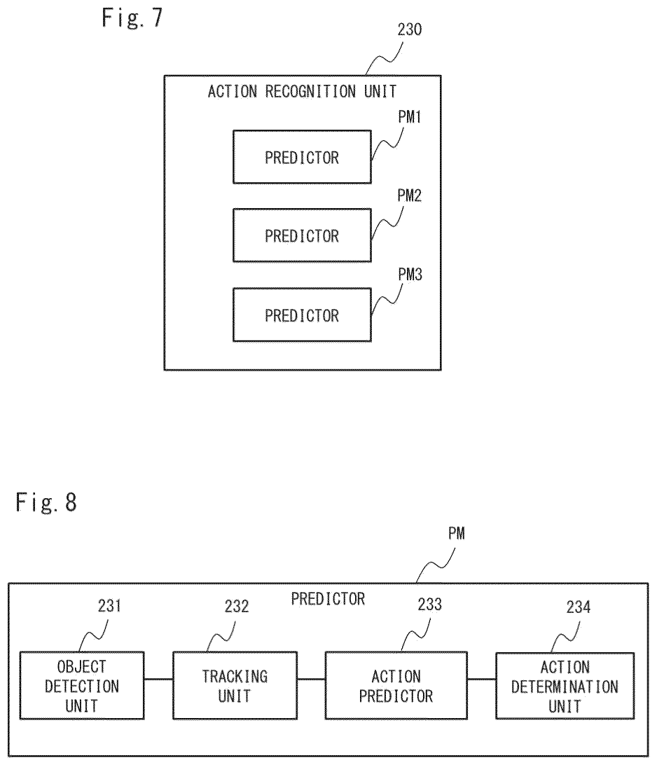

FIG. 7 illustrates a configuration example of the action recognition unit 230 in the center server 200. As illustrated in FIG. 7, the action recognition unit 230 includes a plurality of predictors PM1 to PM3. Note that the number of predictors PM is not limited to three, and any number of predictors PM may be provided. Each of the predictors PM1 to PM3 predicts an action of an object in the reception video, that is, recognizes the action. The predictors PM1 to PM3 may be learning models having the same configuration, but learn data sets of different learning data. For example, the predictors PM1 to PM3 learn, as learning data, videos obtained by imaging the same action or the same type of actions at different work sites (environments). The learning model of the predictor is an object recognition engine or an action recognition engine. Note that the predictors PM1 to PM3 may be learning models in which different actions or different types of actions are learned. For example, one predictor may be learning a first action, such as an action in excavation work, and another predictor may be learning a second action, such as an action in ground leveling work. In this case, the learning data of the excavation work and the learning data of the ground leveling work may be videos captured in the same environment. The different actions learned by the predictors may be actions that can be performed simultaneously or actions that cannot be performed simultaneously.

FIG. 8 illustrates a configuration example of the predictor PM in FIG. 7. FIG. 8 is a configuration example in a case where the action recognition with the relevance between the person and the work object is performed on the machine learning basis. In the example of FIG. 8, the predictor PM of the action recognition unit 230 includes an object detection unit 231, a tracking unit 232, an action predictor 233, and an action determination unit 234.

The object detection unit 231 detects an object in the input reception video. For example, similarly to the detection unit 120 of the terminal 100, the object detection unit 231 is a detection unit such as an object recognition engine using machine learning. That is, the object detection unit 231 extracts a rectangular region including an object from each image of the reception video, recognizes the object in the extracted rectangular region, and gives a label of the recognized object. The detection result of the object includes the object label and position information of the rectangular region including the object.

The tracking unit 232 tracks the detected object in the reception video. The tracking unit 232 associates the object of each image included in the reception video based on the detection result of the object. By assigning a tracking ID to the detected object, each object can be identified and tracked. For example, an object is tracked by associating objects between images by a distance or overlap (for example, intersection over union (IoU)) between a rectangular region of an object detected in a previous image and a rectangular region of an object detected in the next image.

The action predictor 233 predicts an action of an object for each object tracked by the tracking unit 232. The action predictor 233 recognizes the action of a person tracked in the reception video and gives a label of the recognized action. For example, the action predictor 233 recognizes the action of the person in the reception video by the action recognition engine using machine learning such as deep learning. The action of the person can be recognized by performing machine learning on the video of the person who performs the work using the work object and the action label. For example, machine learning is performed by using learning data that is a video of a person who is working using a work object, annotation information such as positions of the person and the work object and related information between the person and the object, and action information such as a work object necessary for each work. In addition, the action predictor 233 outputs the score of the recognized action label.

The action determination unit 234 determines an action of an object based on the predicted action label. The action determination unit 234 determines the action of the person based on the score of the action label predicted by the action predictor 233. For example, the action determination unit 234 outputs an action label having the highest score, as a recognition result. Note that the recognition result may include scores of a plurality of action labels predicted by the action predictor 233.

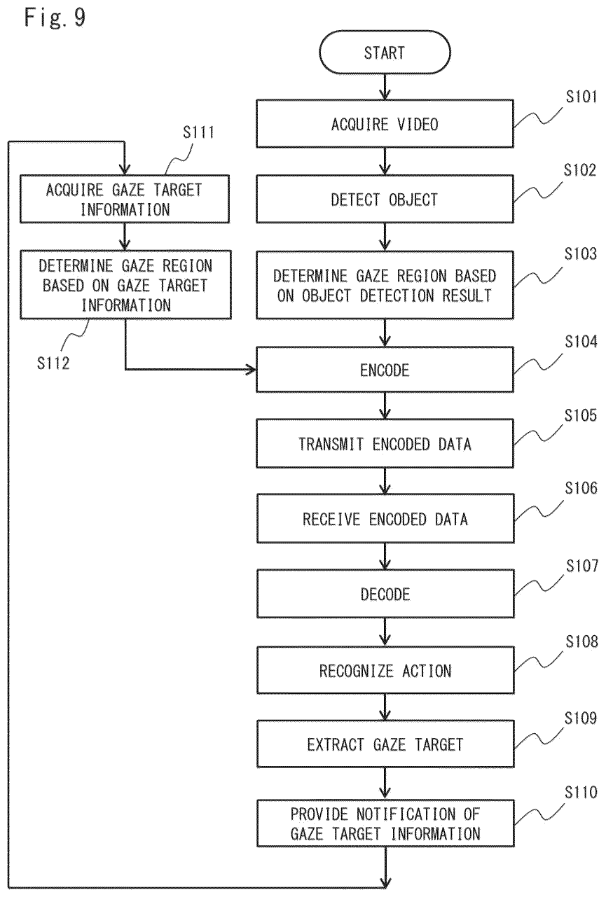

Next, an operation of the remote monitoring system according to the present example embodiment will be described. FIG. 9 illustrates an operation example of the remote monitoring system 1. For example, description will be made on the assumption that the terminal 100 executes S101 to S105 and S111 and S112, and the center server 200 executes S106 to S110, but the present example embodiment is not limited thereto, and any apparatus may execute each process.

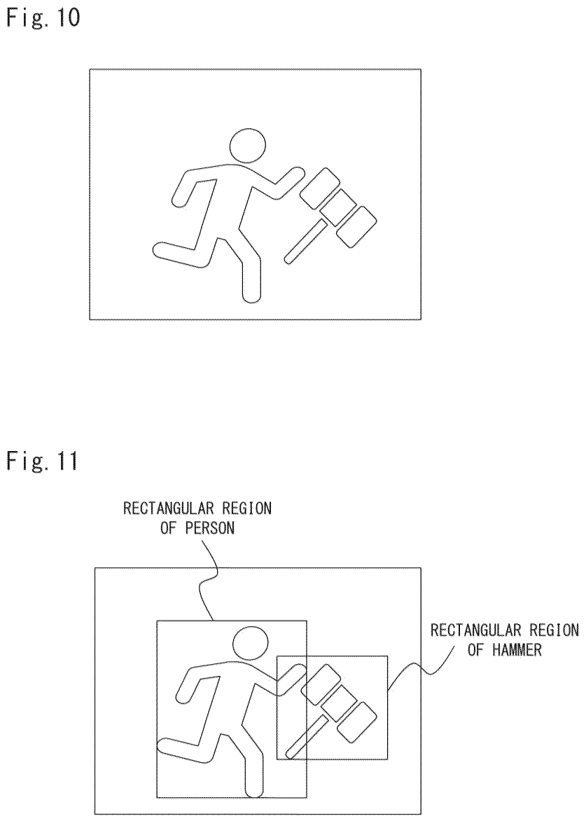

As illustrated in FIG. 9, the terminal 100 acquires a video from the camera 101 (S101). The camera 101 generates a video obtained by imaging the site, and the video acquisition unit 110 acquires a video (input video) output from the camera 101. For example, as illustrated in FIG. 10, the image of the input video includes a person who performs work on site and a work object such as a hammer used by the person.

Subsequently, the terminal 100 detects an object based on the acquired input video (S102). The detection unit 120 detects a rectangular region in an image included in the input video using the object recognition engine, recognizes an object in the detected rectangular region, and gives a label of the recognized object. For each detected object, the detection unit 120 outputs an object label and position information of a rectangular region of the object as the object detection result. For example, in a case where object detection is performed from the image of FIG. 10, a person and a hammer are detected, and a rectangular region of the person and a rectangular region of the hammer are detected as illustrated in FIG. 11.

Subsequently, the terminal 100 determines a gaze region in the input video based on the object detection result (S103). The first determination unit 131 of the image quality change determination unit 130 extracts an object having a label as a gaze target, based on the object detection result of each object. The first determination unit 131 extracts an object having an object label that is a person or a work object from the detected object, and determines a rectangular region of the extracted object as a gaze region. In the example of FIG. 11, a person and a hammer are detected in the image, and since the hammer corresponds to a work object, a rectangular region of the person and a rectangular region of the hammer are determined as gaze regions.

Subsequently, the terminal 100 encodes the input video based on the determined gaze region (S104). The compression efficiency determination unit 140 encodes the input video such that the gaze region has higher image quality than other regions. In the example of FIG. 11, the compression rates of the rectangular region of the person and the rectangular region of the hammer are made lower than the compression rates of the other regions, thereby improving the image quality of the rectangular region of the person and the rectangular region of the hammer.

Subsequently, the terminal 100 transmits the encoded data to the center server 200 (S105), and the center server 200 receives the encoded data (S106).

The terminal communication unit 150 transmits encoded data obtained by improving the image quality of the gaze region to the base station 300. The base station 300 transfers the received encoded data to the center server 200 via the core network or the Internet. The center communication unit 210 receives the transferred encoded data from the base station 300.

Subsequently, the center server 200 decodes the received encoded data (S107). The decoder 220 decodes the encoded data in accordance with the compression rate of each region, and generates a video (reception video) in which the gaze region is improved in image quality.

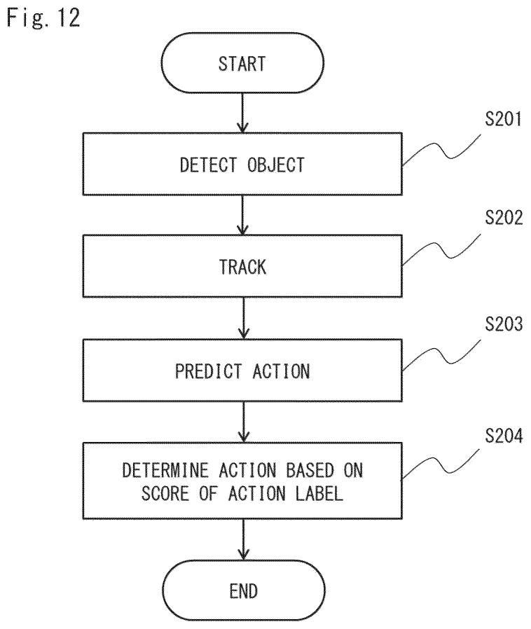

Subsequently, the center server 200 recognizes an action of an object based on the decoded reception video (S108). Each of the predictors PM1 to PM3 of the action recognition unit 230 analyzes the reception video and recognizes the action of the object. FIG. 12 illustrates an example of action recognition processing by the predictor PM of the action recognition unit 230 illustrated in FIG. 8.

In the example of FIG. 12, first, the object detection unit 231 detects an object in the input reception video (S201). The object detection unit 231 detects a rectangular region in each image included in the reception video using the object recognition engine, recognizes an object in the detected rectangular region, and gives a label of the recognized object. For each detected object, the object detection unit 231 outputs an object label and position information of the rectangular region of the object as the object detection result.

Subsequently, the tracking unit 232 tracks the detected object in the reception video (S202). The tracking unit 232 assigns a tracking ID to each detected object, and tracks the object identified by the tracking ID with each image.

Subsequently, the action predictor 233 predicts an action of an object for each tracked object (S203). The action predictor 233 predicts an action of a person from a video including the tracked person and a work object by using the action recognition engine. The action predictor 233 outputs a label of the predicted action and a score of each action label.

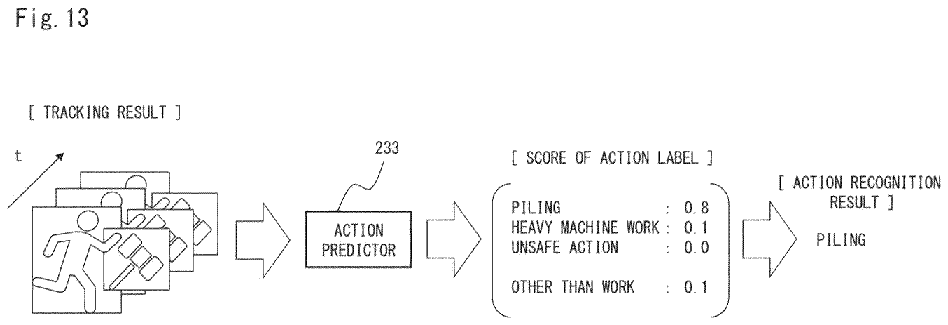

Subsequently, the action determination unit 234 determines the action of the object based on the score of the predicted action label (S204). In the example of FIG. 13, a person and a hammer are detected by tracking. The action predictor 233 recognizes the action of the person based on the video of the detected person and hammer, and outputs the score of each action label. For example, the score of piling is 0.8, the score of heavy machine work is 0.1, the score of an unsafe action is 0.0, and the score of non-work is 0.1. Then, the action determination unit 234 determines that the action of the person is piling because the score of piling is the highest. The action determination unit 234 outputs the determined action and the score of the action.

Returning to FIG. 9, following the action recognition processing, the center server 200 extracts a gaze target based on the analysis information analyzed by the action recognition processing (S109). The gaze target analysis unit 250 may set a person having the recognized action as the gaze target, and further include a work object as the gaze target in a case where the recognition target includes the work object. For example, in the example of FIG. 13, since work of piling is recognized from a person and a hammer, the person having recognized the work and the hammer may be set as the gaze targets. The gaze target analysis unit 250 outputs gaze target extraction information including the position information of the extracted gaze target.

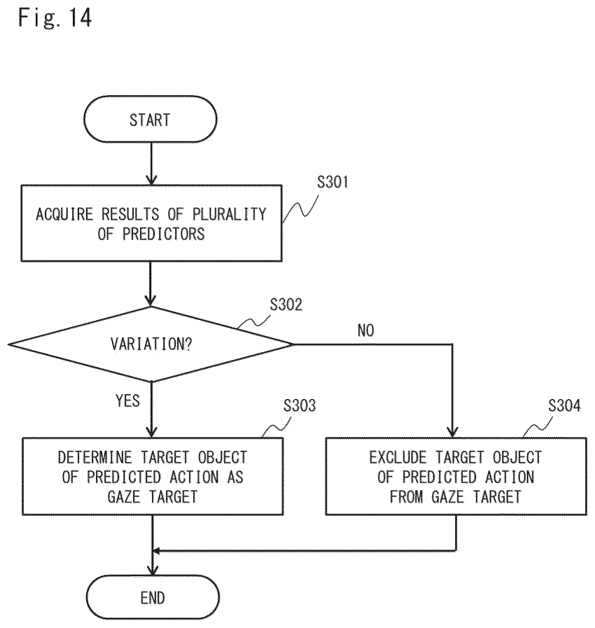

In the present example embodiment, a gaze target is extracted based on the uncertainty of the action recognition result. FIG. 14 illustrates an operation example of gaze target extraction processing according to the present example embodiment. In a case where actions of a plurality of objects are recognized, the gaze target extraction processing is performed on a recognition result of each object. In the example of FIG. 14, first, the gaze target analysis unit 250 acquires prediction results of a plurality of predictors, that is, action recognition results (S301). For example, the gaze target analysis unit 250 acquires action recognition results including action labels and scores predicted by the predictors PM1 to PM3 of the action recognition unit 230. For example, an action label having the highest score output by the action determination unit 234 of each predictor is acquired. Note that a plurality of action labels and scores output from the action predictor 233 of each predictor may be acquired, or any number of action labels among the plurality of action labels output from the action predictor 233 of each predictor may be acquired. For example, top three action labels with high scores may be acquired. In a case where a plurality of action labels are acquired from each predictor, the gaze target is extracted based on variation in the plurality of action labels of each predictor.

Subsequently, the gaze target analysis unit 250 determines variation in the plurality of action recognition results (S302). For example, the gaze target analysis unit 250 determines variation in action labels included in the action recognition results of the plurality of predictors. The presence or absence of variation in action labels may be determined, or the magnitudes of the variation may be determined. In addition, the variation is not limited to the variation in the action labels, and the variation may be determined including the scores of the action labels.

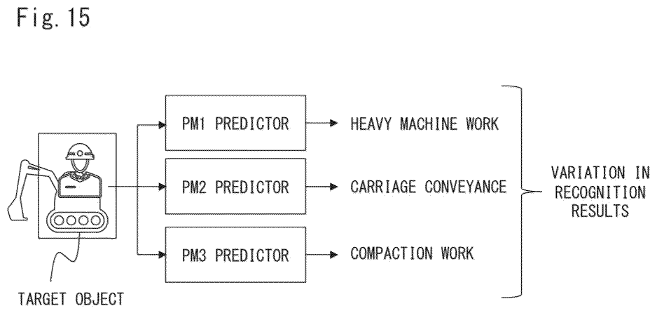

If it is determined that the plurality of action recognition results vary, the gaze target analysis unit 250 determines, as the gaze target, a target object that performs the predicted action (S303). For example, in a case where there is variation in the action labels, the gaze target analysis unit 250 determines the target object of the action labels as the gaze target. FIG. 15 illustrates an example in which it is determined that there is variation in the recognition results in a case where the predictors PM1 to PM3 learn the same action. For example, the predictors PM1 to PM3 learn the same work imaged in different environments. In the example of FIG. 15, since the action label of the prediction result of the predictor PM1 is heavy machine work, the action label of the prediction result of the predictor PM2 is carriage conveyance, and the action label of the prediction result of the predictor PM3 is compaction work, and the prediction results are different from each other, it is determined that there is variation, and the predicted target object is determined as the gaze target.

In addition, in a case where the variation in the action labels is large, the gaze target analysis unit 250 may determine the target object of the action label as the gaze target. For example, in a case where a number M of matching action labels each having the highest score in the N predictors is equal to or less than a threshold T, the predicted target object is determined as the gaze target. For example, in a case where the action label of the prediction result of the predictor PM1 is carriage conveyance, the action label of the prediction result of the predictor PM2 is compaction work, the action label of the prediction result of the predictor PM3 is carriage conveyance, and the action label of the prediction result of the predictor PM4 is heavy machine work, N=4 and M=2 are satisfied, i T=3, M<T is satisfied, and thus it is determined that the variation is large, and the predicted target object is determined as the gaze target.

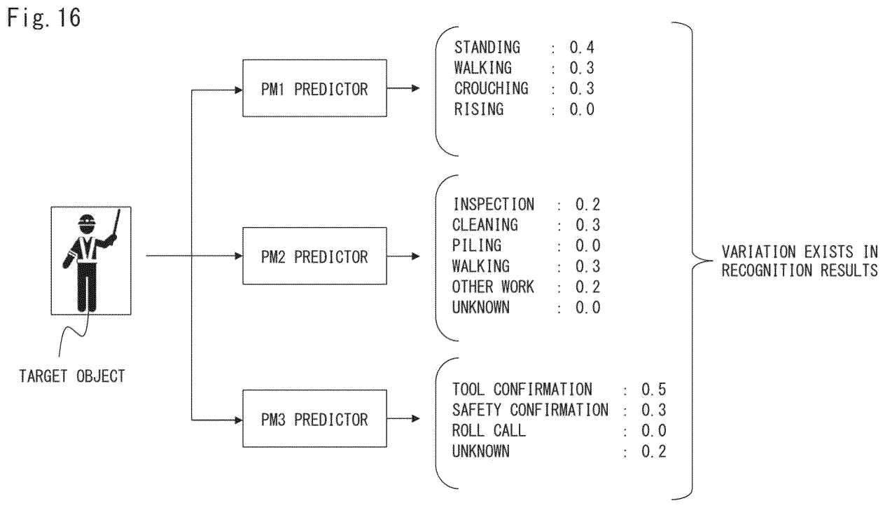

FIG. 16 illustrates an example in which it is determined that there is variation in the recognition results in a case where the predictors PM1 to PM3 learn different actions. In this example, the predictors PM1 to PM3 learn different actions which are imaged in the same environment and can be performed simultaneously. For example, the predictor PM1 is a predictor that has learned a posture (skeleton) of an action of a person, the predictor PM2 is a predictor that has learned content (work) of the action of the person, and the predictor PM3 is a predictor that has learned detailed information of inspection work among the actions recognized by the predictor PM2. As illustrated in FIG. 16, in the posture recognition result of the predictor PM1, the scores of standing, walking, and crouching are almost the same, so that the posture of the target object is unknown, and in the action recognition result of the predictor PM2, the scores of inspection, cleaning, walking, and other work are almost the same, so that the action of the target object is unknown. In this case, since the recognition results of the predictors PM1 and PM2 each include a plurality of action labels having the same degree or a score equal to or larger than a predetermined value, it is determined that the recognition results of the predictors PM1 to PM3 vary, and the target object is determined as the gaze target.

In addition, in a case where a plurality of predictors learn different types of actions which cannot be performed simultaneously, it is expected that the predictor that reacts to the action of the target object is limited to only the predictor that has learned the target action. For example, in an example in which the predictor A and the predictor B are used, it is assumed that the compaction work and the heavy machine work cannot be performed simultaneously, and the predictor A learns compaction work and the predictor B learns heavy machine work. In this example, in a case where a worker is performing the compaction work, it is expected that only the predictor A reacts, the score of the compaction work increases, and the score of the heavy machine work of the predictor B is low. Therefore, if the score values of both the predictors become high, it can be determined that the action cannot be distinguished and the uncertainty of the recognition is high. Therefore, it may be determined that the uncertainty is high if there is a plurality of action classes equal to or larger than a certain score threshold across different predictors. For example, in a case where the score of the compaction work is 0.8 in the recognition result of the predictor A, the score of the heavy machine work is 0.9 in the recognition result of the predictor B, and the score threshold is 0.6, the number of action classes exceeding the score threshold is 2, and thus it is determined that the uncertainty is high.

If it is determined that the plurality of prediction results do not vary, the gaze target analysis unit 250 excludes, from the gaze target, the target object that performs the predicted action (S304). That is, in this case, the gaze target analysis unit 250 does not select the object as the gaze target. For example, in a case where there is no variation in the action labels, the gaze target analysis unit 250 does not select the target object of the action label as the gaze target.

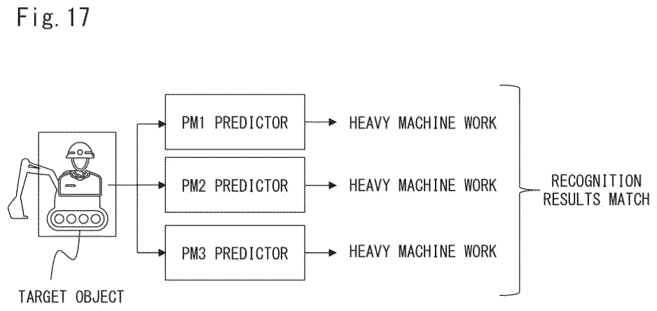

Similarly to FIG. 15, FIG. 17 illustrates an example in which it is determined that there is no variation in the recognition results in a case where the predictors PM1 to PM3 learn the same action. Similarly to FIG. 15, for example, the predictors PM1 to PM3 learn the same work imaged in different environments. In the example of FIG. 17, since the action labels of the prediction results of the predictors PM1 to PM3 are all heavy machine work and the prediction results match, it is determined that there is no variation, and the predicted target object is excluded from the gaze target.

In addition, in a case where the variation in the action labels is small, the gaze target analysis unit 250 may exclude the target object of the action label from the gaze target. For example, in a case where the number M of matching action labels each having the highest score in the N predictors is larger than the threshold T, the prediction target is excluded from the gaze target. For example, in a case where the action label of the prediction result of the predictor PM1 is carriage conveyance, the action label of the prediction result of the predictor PM2 is carriage conveyance, the action label of the prediction result of the predictor PM3 is carriage conveyance, and the action label of the prediction result of the predictor PM4 is heavy machine work, N=4 and M=3 are satisfied, if T=2, M>T is satisfied, and thus it is determined that the variation is small, and the predicted target object is excluded from the gaze target.

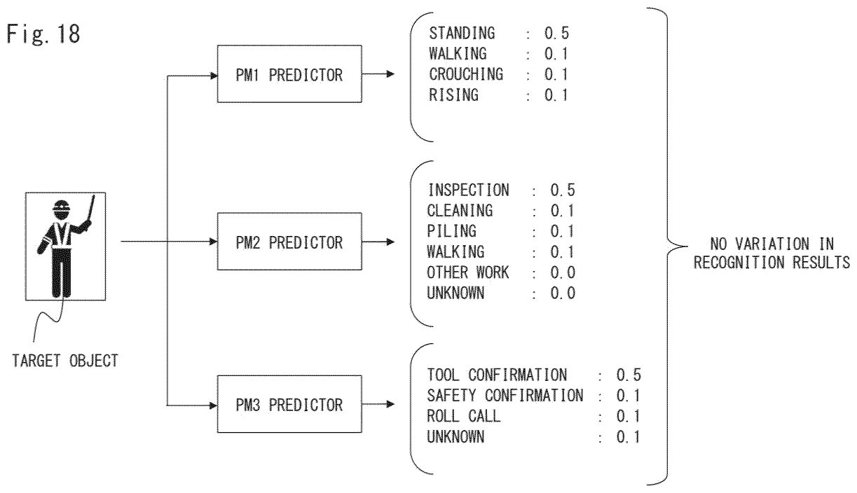

Similarly to FIG. 16, FIG. 18 illustrates an example in which it is determined that there is no variation in the recognition results in a case where the predictors PM1 to PM3 learn different actions. Similarly to FIG. 16, the predictors PM1 to PM3 learn different actions which are imaged in the same environment and can be performed simultaneously. For example, the predictor PM1 is a predictor that has learned a posture (skeleton) of the action of the person, the predictor PM2 is a predictor that has learned content (work) of the action of the person, and the predictor PM3 is a predictor that has learned detailed information of inspection work among the actions recognized by the predictor PM2. As illustrated in FIG. 18, in the posture recognition result of the predictor PM1, since only the score of standing is high and the other scores are low, it is predicted that the posture of the target object is the standing position. In the action recognition result of the predictor PM2, since only the score of inspection is high and the other scores are low, it is predicted that the action of the target object is the inspection. In the inspection work recognition result of the predictor PM3, since only the score of tool confirmation is high and the other scores are low, it is predicted that the inspection work of the target object is the tool confirmation. Accordingly, it is possible to recognize that the person of the target object is performing the inspection work of confirming the presence or absence of a tool while standing. In this case, in the recognition results of the predictors PM1 to PM3, since there is one action label having a score equal to or larger than the predetermined value, it is determined that the recognition results of the predictors PM1 to PM3 do not vary, and the target object is excluded from the gaze target.

In addition, in an example in which a plurality of predictors learn different types of actions which cannot be performed simultaneously, in a case where there is no plurality of action classes equal to or larger than the score threshold across different predictors, for example, in a case where there is only one action class equal to or larger than a certain score threshold, it may be determined that the uncertainty is low.

Returning to FIG. 9, following the gaze target extraction processing, the center server 200 notifies the terminal 100 of the extraction gaze target information extracted in the gaze target extraction processing (S110), and the terminal 100 acquires the extraction gaze target information (S111). The center communication unit 210 transmits the extraction gaze target information indicating the position of the extracted gaze target to the base station 300 via the Internet or the core network. The base station 300 transfers the received extraction gaze target information to the terminal 100. The terminal communication unit 150 receives the transferred extraction gaze target information from the base station 300.

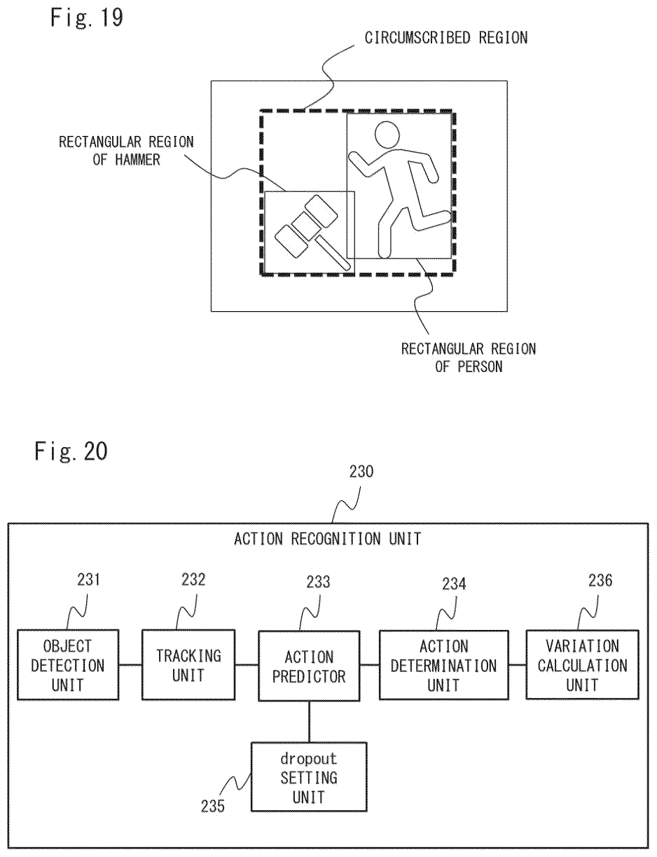

Subsequently, the terminal 100 determines the gaze region based on the received extraction gaze target information (S112). The second determination unit 132 of the image quality change determination unit 130 determines a region indicated by the extraction gaze target information notification of which is provided from the center server 200 as the gaze region. In the example of FIG. 19, the extraction gaze target information indicates a rectangular region of a person and a rectangular region of a hammer, and these regions are determined as the gaze regions. In addition, a circumscribed region including the rectangular region of the person and the rectangular region of the hammer may be set as the gaze region. Notification of the circumscribed region may be provided from the center server 200 to the terminal 100. Thereafter, S104 to S112 are repeated.

As described above, in the present example embodiment, in the system that recognizes the action of the object from the video, the gaze target is extracted based on the uncertainty of the action recognition result, and the image quality of the region including the extracted gaze target is improved. For example, it is assumed that in a case where the action recognition results vary, correct recognition cannot be made from the video. Therefore, by making a determination based on the uncertainty of the action recognition result, it is possible to appropriately select a target to be gazed at. Therefore, according to the action recognition result, the image quality of a specific portion including the target to be gazed at is secured, and the other regions can be compressed, so that an action recognition error can be prevented while the amount of data to be transmitted is suppressed.

### Second Example Embodiment

Next, a second example embodiment will be described. In the present example embodiment, an example will be described in which the uncertainty of the action recognition result is output from the action recognition unit. Since the configuration other than the action recognition unit is similar to that in FIGS. 5 and 6 of the first example embodiment, description thereof will be omitted. Note that the present example embodiment can be implemented in combination with the first example embodiment, and each component described in the first example embodiment may be appropriately used.

FIG. 20 illustrates a configuration example of the action recognition unit 230 according to the present example embodiment. As illustrated in FIG. 20, the action recognition unit 230 according to the present example embodiment includes the object detection unit 231, the tracking unit 232, the action predictor 233, and the action determination unit 234 similar to the predictor PM in FIG. 8, and further includes a dropout setting unit 235 and a variation calculation unit 236.

The dropout setting unit 235 sets dropout in the neural network of the action predictor 233. The variation calculation unit 236 calculates variation in prediction results predicted a plurality of times by the action predictor 233 in which dropout is set, that is, variation in recognition results recognized a plurality of times.

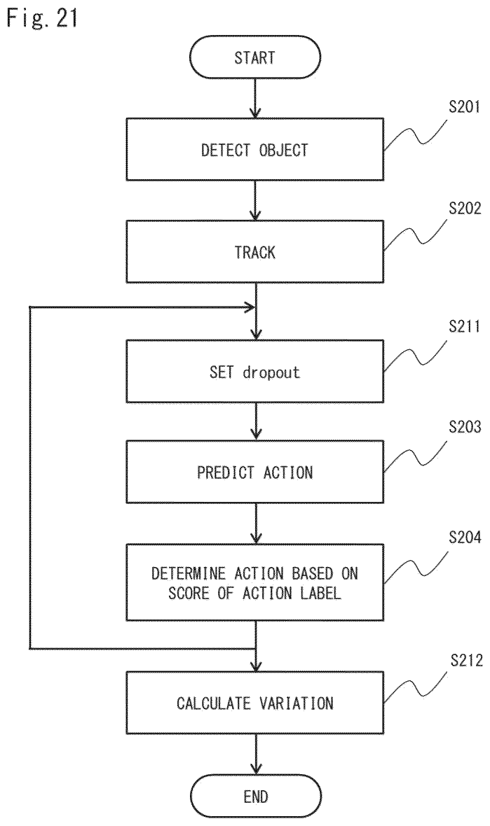

FIG. 21 illustrates an example of action recognition processing by the action recognition unit 230 illustrated in FIG. 20. Note that other operations are similar to those of the first example embodiment in FIG. 9. In the example of FIG. 21, first, similarly to the first example embodiment, the object detection unit 231 detects an object in an input reception video (S201), and the tracking unit 232 tracks the detected object in the reception video (S202).

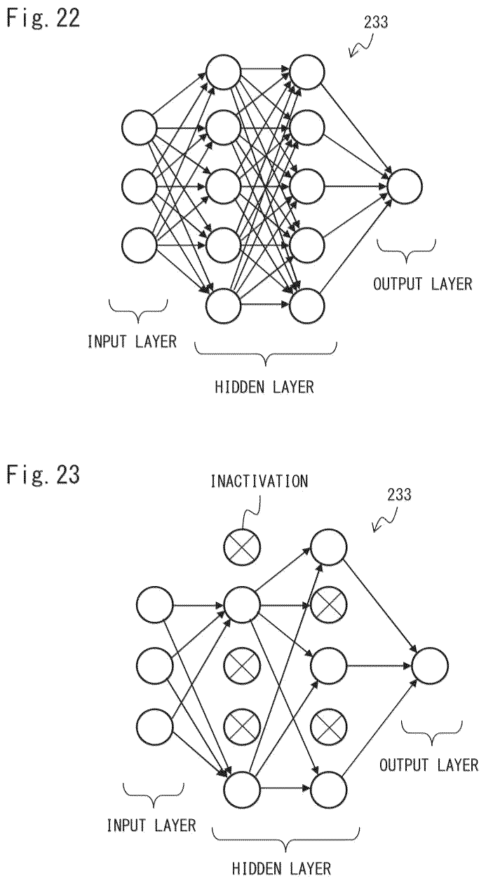

Subsequently, the dropout setting unit 235 sets dropout in the action predictor 233 (S211). For example, as illustrated in FIG. 22, it is assumed that the neural network of the action predictor 233 includes an input layer, a hidden layer (intermediate layer), and an output layer. In this example, the input layer includes a plurality of nodes, and the hidden layer includes a plurality of nodes.

In this case, as illustrated in FIG. 23, for example, the dropout setting unit 235 selects a node of the hidden layer and inactivates the selected node. A randomly selected node may be inactivated, or a node may be selected to be inactivated, so as to have a predetermined dropout rate. Note that not only a node of the hidden layer but also a node of the input layer may be inactivated.

In a state where dropout is set and a predetermined node is inactivated, the action predictor 233 predicts an action of an object (S203) similarly to the first example embodiment, and the action determination unit 234 determines an action of an object based on a score of a predicted action label (S204). The action determination unit 234 outputs the determined action recognition result. Further, S211, S203, and S204 are repeated a plurality of times, and action recognition by dropout is performed a plurality of times. The plurality of times of recognition may be performed by sequentially repeating the processes of S211, S203, and S204, or a series of processes of S211, S203, and S204 may be duplicated and performed in parallel. However, the node to be inactivated in S211 is set to be different every time in the plurality of times of recognition.

Thereafter, the variation calculation unit 236 calculates variation in a plurality of action recognition results obtained by predicting an action a plurality of times (S212). Similarly to the first example embodiment, the variation calculation unit 236 may calculate variation in action labels included in the action recognition results, or may calculate variation in scores of the action labels. The variation calculation unit 236 may determine the presence or absence of variation in action labels and output the determination result. In a case where the action labels of the plurality of action recognition results are different from each other, “variation exists” is output as a variation calculation result, and in a case where the action labels of the plurality of action recognition results match, “no variation” is output as a variation calculation result.

In addition, the variation calculation unit 236 may determine whether the variation in action labels of the plurality of action recognition results is larger than a threshold, and output a determination result. Similarly to the first example embodiment, for example, if the number M of matching action labels each having the highest score in N times of action recognition (inference) is equal to or less than the threshold T, “variation exists” is output as a variation calculation result, and if the number M of matching action labels each having the highest score is larger than the threshold T, “no variation” is output as a variation calculation result. A variation degree, which is a ratio of the number M of matching action labels each having the highest score to the N times of action recognition, may be output as the variation calculation result. Note that, similarly to the first example embodiment, the gaze target analysis unit 250 may calculate and determine the variation.

Thereafter, similarly to the first example embodiment, the gaze target analysis unit 250 extracts a gaze target based on the variation calculation result calculated by the variation calculation unit 236 of the action recognition unit 230. For example, in a case where the presence or absence of variation is output as the variation calculation result, if there is variation, the target object of the action recognition result is determined as the gaze target. In a case where the variation degree is output as the variation calculation result, the gaze target may be determined according to a comparison result between the variation degree and the threshold.

As described above, the gaze target may be extracted using a single action predictor that outputs the uncertainty of action prediction. Even in this case, similarly to the first example embodiment, the gaze target can be appropriately selected, and thus it is possible to prevent an action recognition error while suppressing the amount of data to be transmitted. In addition, the uncertainty of the recognition result can be determined without preparing a plurality of predictors.

Note that the present disclosure is not limited to the above-described example embodiments, and can be appropriately modified without departing from the scope. For example, in the above example embodiments, the center server extracts the gaze target, and the terminal determines the gaze region based on the extracted gaze target. However, the center server may determine the gaze region based on the extracted gaze target. In this case, the center server may notify the terminal of the coordinates of the gaze region and the size of the region.

In addition, the processing flow described in the above example embodiments is an example, and the order of each processing is not limited to the above example. The order of part of the processing may be changed and executed, or part of the processing may be executed in parallel.

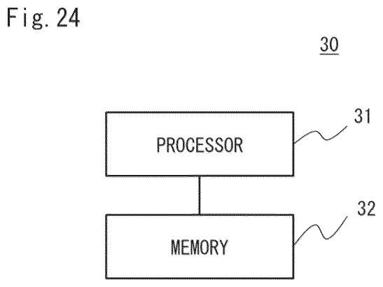

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 24. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following supplementary notes, but are not limited to the following supplementary notes.

### (Supplementary Note 1)

A video processing system including:
an image quality control means for controlling image quality of a gaze region including a gaze target in an input video;
a recognition means for performing recognition processing regarding an object included in the video in which the image quality of the gaze region is controlled; and
an extraction means for extracting the gaze target based on uncertainty of a recognition result of the recognition processing.

### (Supplementary Note 2)

The video processing system according to supplementary note 1, in which the recognition processing includes processing of recognizing an action of the object, and
the extraction means extracts the gaze target based on variation in recognition results of the action.

### (Supplementary Note 3)

The video processing system according to supplementary note 2, in which in a case where the variation in the action recognition results is not included in a predetermined range, the extraction means determines an object of the recognized action as the gaze target.

### (Supplementary Note 4)

The video processing system according to supplementary note 2 or 3, in which
the recognition means includes a plurality of action predictors that have learned different learning data, and
the extraction means extracts the gaze target based on variation in a plurality of action recognition results output from the plurality of action predictors.

### (Supplementary Note 5)

The video processing system according to supplementary note 2 or 3, in which
the recognition means includes an action predictor, and
the extraction means extracts the gaze target based on variation in a plurality of action recognition results output by the action predictor recognizing an action a plurality of times.

### (Supplementary Note 6)

The video processing system according to any one of supplementary notes 2 to 5, in which the extraction means extracts the gaze target based on variation in action labels included in the action recognition results or variation in scores of the action labels.

### (Supplementary Note 7)

The video processing system according to supplementary note 5, in which the action predictor outputs the plurality of action recognition results by inactivating different nodes of a neural network for each recognition of the action.

### (Supplementary Note 8)

A video processing method including:
controlling image quality of a gaze region including a gaze target in an input video;
performing recognition processing regarding an object included in the video in which the image quality of the gaze region is controlled; and
extracting the gaze target based on uncertainty of a recognition result of the recognition processing.

### (Supplementary Note 9)

The video processing method according to supplementary note 8, in which the recognition processing includes processing of recognizing an action of the object, and
the gaze target is extracted based on variation in recognition results of the action.

### (Supplementary Note 10)

The video processing method according to supplementary note 9, in which in the extraction of the gaze target, in a case where the variation in the action recognition results is not included in a predetermined range, an object of the recognized action is determined as the gaze target.

### (Supplementary Note 11)

The video processing method according to supplementary note 9 or 10, in which
the action of the object is recognized by a plurality of action predictors that have learned different learning data; and
the gaze target is extracted based on variation in a plurality of action recognition results output from the plurality of action predictors.

### (Supplementary Note 12)

The video processing method according to supplementary note 9 or 10, in which
the action of the object is recognized by an action predictor, and the gaze target is extracted based on variation in a plurality of action recognition results output by the action predictor recognizing an action a plurality of times.

### (Supplementary Note 13)

The video processing method according to any one of supplementary notes 9 to 12, in which the gaze target is extracted based on variation in action labels included in the action recognition results or variation in scores of the action labels.

### (Supplementary Note 14)

The video processing method according to supplementary note 12, in which the action predictor outputs the plurality of action recognition results by inactivating different nodes of a neural network for each recognition of the action.

### (Supplementary Note 15)

A video processing apparatus including:
an image quality control means for controlling image quality of a gaze region including a gaze target in an input video;
a recognition means for performing recognition processing regarding an object included in the video in which the image quality of the gaze region is controlled; and
an extraction means for extracting the gaze target based on uncertainty of a recognition result of the recognition processing.

### (Supplementary Note 16)

The video processing apparatus according to supplementary note 15, in which
the recognition processing includes processing of recognizing an action of the object, and
the extraction means extracts the gaze target based on variation in recognition results of the action.

### (Supplementary Note 17)

The video processing apparatus according to supplementary note 16, in which in a case where the variation in the action recognition results is not included in a predetermined range, the extraction means determines an object of the recognized action as the gaze target.

### (Supplementary Note 18)

The video processing apparatus according to supplementary note 16 or 17, in which
the recognition means includes a plurality of action predictors that have learned different learning data, and
the extraction means extracts the gaze target based on variation in a plurality of action recognition results output from the plurality of action predictors.

### (Supplementary Note 19)

The video processing apparatus according to supplementary note 16 or 17, in which
the recognition means includes an action predictor, and
the extraction means extracts the gaze target based on variation in a plurality of action recognition results output by the action predictor recognizing an action a plurality of times.

### (Supplementary Note 20)

The video processing apparatus according to supplementary note 19, in which the action predictor outputs the plurality of action recognition results by inactivating different nodes of a neural network for each recognition of the action.

### REFERENCE SIGNS LIST

1 REMOTE MONITORING SYSTEM
10 VIDEO PROCESSING SYSTEM
11 IMAGE QUALITY CONTROL UNIT
12 RECOGNITION UNIT
13 EXTRACTION UNIT
20 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
103 VIDEO TRANSMISSION FUNCTION
110 VIDEO ACQUISITION UNIT
120 DETECTION UNIT
130 IMAGE QUALITY CHANGE DETERMINATION UNIT
131 FIRST DETERMINATION UNIT
132 SECOND DETERMINATION UNIT
140 COMPRESSION EFFICIENCY DETERMINATION UNIT
150 TERMINAL COMMUNICATION UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODER
230 ACTION RECOGNITION UNIT
231 OBJECT DETECTION UNIT
232 TRACKING UNIT
234 ACTION DETERMINATION UNIT
235 dropout SETTING UNIT
236 VARIATION CALCULATION UNIT
240 ANALYSIS INFORMATION STORAGE UNIT
250 GAZE TARGET ANALYSIS UNIT
300 BASE STATION
400 MEC
401 COMPRESSION BIT RATE CONTROL FUNCTION
402 TERMINAL CONTROL FUNCTION
PM, PM1 to PM3 PREDICTOR

What is claimed is:

1. A video processing system comprising:
a memory configured to store instructions, and
a processor configured to execute the instructions to;
control image quality of a gaze region including a gaze target in an input video;
perform recognition processing regarding an object included in the video in which the image quality of the gaze region is controlled; and
extract the gaze target based on uncertainty of a recognition result of the recognition processing.

2. The video processing system according to claim 1, wherein
the recognition processing includes processing of recognizing an action of the object, and
the processor is further configured to execute the instructions to extract the gaze target based on variation in recognition results of the action.

3. The video processing system according to claim 2, wherein in a case where the variation in the action recognition results is not included in a predetermined range, the processor is further configured to execute the instructions to determine an object of the recognized action as the gaze target.

4. The video processing system according to claim 2, wherein
the video processing system further comprises a plurality of action predictors that have learned different learning data, and
the processor is further configured to execute the instructions to extract the gaze target based on variation in a plurality of action recognition results output from the plurality of action predictors.

5. The video processing system according to claim 2, wherein
the video processing system further comprises an action predictor, and
the processor is further configured to execute the instructions to extract the gaze target based on variation in a plurality of action recognition results output by the action predictor recognizing an action a plurality of times.

6. The video processing system according to claim 2, wherein the processor is further configured to execute the instructions to extract the gaze target based on variation in action labels included in the action recognition results or variation in scores of the action labels.

7. The video processing system according to claim 5, wherein the action predictor outputs the plurality of action recognition results by inactivating different nodes of a neural network for each recognition of the action.

8. A video processing method comprising:
controlling image quality of a gaze region including a gaze target in an input video;
performing recognition processing regarding an object included in the video in which the image quality of the gaze region is controlled; and
extracting the gaze target based on uncertainty of a recognition result of the recognition processing.

9. The video processing method according to claim 8, wherein
the recognition processing includes processing of recognizing an action of the object, and
the gaze target is extracted based on variation in recognition results of the action.

10. The video processing method according to claim 9, wherein in the extraction of the gaze target, in a case where the variation in the action recognition results is not included in a predetermined range, an object of the recognized action is determined as the gaze target.

11. The video processing method according to claim 9, wherein
the action of the object is recognized by a plurality of action predictors that have learned different learning data, and
the gaze target is extracted based on variation in a plurality of action recognition results output from the plurality of action predictors.

12. The video processing method according to claim 9, wherein
the action of the object is recognized by an action predictor, and
the gaze target is extracted based on variation in a plurality of action recognition results output by the action predictor recognizing an action a plurality of times.

13. The video processing method according to claim wherein the gaze target is extracted based on variation in action labels included in the action recognition results or variation in scores of the action labels.

14. The video processing method according to claim 12, wherein the action predictor outputs the plurality of action recognition results by inactivating different nodes of a neural network for each recognition of the action.

15. A video processing apparatus comprising:
a memory configured to store instructions, and
a processor configured to execute the instructions to;
control image quality of a gaze region including a gaze target in an input video;
perform recognition processing regarding an object included in the video in which the image quality of the gaze region is controlled; and
extract the gaze target based on uncertainty of a recognition result of the recognition processing.

16. The video processing apparatus according to claim 15, wherein
the recognition processing includes processing of recognizing an action of the object, and
the processor is further configured to execute the instructions to extract the gaze target based on variation in recognition results of the action.

17. The video processing apparatus according to claim 16, wherein in a case where the variation in the action recognition results is not included in a predetermined range, the processor is further configured to execute the instructions to determine an object of the recognized action as the gaze target.

18. The video processing apparatus according to claim 16, wherein
the video processing apparatus further comprises a plurality of action predictors that have learned different learning data, and
the processor is further configured to execute the instructions to extract the gaze target based on variation in a plurality of action recognition results output from the plurality of action predictors.

19. The video processing apparatus according to claim 16, wherein
the video processing apparatus further comprises an action predictor, and
the processor is further configured to execute the instructions to extract the gaze target based on variation in a plurality of action recognition results output by the action predictor recognizing an action a plurality of times.

20. The video processing apparatus according to claim 19, wherein the action predictor outputs the plurality of action recognition results by inactivating different nodes of a neural network for each recognition of the action.
